(19) United States
(12) Patent Application Publication
(10) Pub. No.: US 2015/0178766 A1
(43) Pub. Date: Jun. 25, 2015

(54) PROMOTION CONFLICT RESOLUTION

(71) Applicant: NCR Corporation, Duluth, GA (US)

(72) Inventors: Dror Ben-Eliezer, Pardes Hanna-Karkur (IL); Jonathan Roy David, Kfar-Saba (IL); Tzur Sayag, Tel Aviv (IL)

(73) Assignee: NCR Corporation, Duluth, GA (US)

(21) Appl. No.: 14/136,665

(22) Filed: Dec. 20, 2013

(51) Int. Cl. G06Q 30/02

(52) U.S. Cl. CPC G06Q 30/0241; G06Q 30/0222; G06Q 30/0226

(57) ABSTRACT

Methods and a system for promotion conflict resolution are provided. During a transaction, which may be associated with a consumer, a variety of available promotions are identified. Permissible permutations (non-conflicting promotion combinations) for the available promotions are dynamically formed, evaluated, and a set of optimal promotions for the transaction is resolved.

### BACKGROUND

Technology has been advancing in recent years at alarming rates. Perhaps, the most amazing aspect of technology advancement is the ease with which new technologies are now integrated into and adopted by industry and society in general.

One area of advancement is referred to as Customer Relationship Management (CRM), where many enterprises can now evaluate and in some cases even anticipate consumer behaviors on an individualized basis (largely because nearly every consumer transaction is now captured electronically in some manner). That is, enterprises can now track the purchasing, traveling, socializing, eating, and viewing habits of consumers with almost alarming detail and accuracy.

As one example situation, consider that every consumer is different, having different wants and needs that can change and evolve over time or in any given situation, so many enterprises may have a variety of promotions for products or services that they offer at any given point in time. In fact, this situation is becoming even more prevalent since CRM technology permits enterprises to become hyper competitive with one another in order to compete for consumer loyalty and consumer dollars.

Furthermore, a product/service can be marketed by a retailer in one manner and by the product's manufacturer in another manner and both marketing campaigns can occur simultaneously with one another and yet be completely different. It may also be that some event organizer for an event, which is unrelated to a retailer or manufacturer of a given product or service, will take up its own promotion for that product or service for purposes of increasing attendance in or viewership for that event. In still more situations, different departments within a same enterprise may intentionally or unintentionally have simultaneous competing promotions for a given product or service. So, competing promotions can come from different enterprises, the same enterprise, and can even be based on other unrelated factors for a specific product or service that is being promoted.

The result of all this ends up being that in many instances consumers are inundated with a variety of promotions and may not even be able to figure out what is the best or what is the most optimal promotion for use because of typical restrictions (conditions, dependencies, etc.) associated with each available promotion.

So, although enterprises have the ability to reach consumers through a variety of technologies and know a lot about what consumers want, the onslaught of competitive offers from the same and different sources have made it very challenging for the average consumer to select and use the best offer for any given situation.

### SUMMARY

In various embodiments, methods and systems for promotion conflict resolution are presented.

According to an embodiment, a method for promotion conflict resolution is provided. Specifically, in an embodiment, a transaction is identified and a set of optimal promotions is selected from available promotions for the transaction.

### BRIEF DESCRIPTION OF THE DRAWINGS

FIG. 1 is a diagram of an example architecture for practicing promotion conflict resolution, according to an example embodiment.

FIG. 2 is a diagram of a method for promotion conflict resolution, according to an example embodiment.

FIG. 3 is a diagram of another method for promotion conflict resolution, according to an example embodiment.

FIG. 4 is a diagram of a promotion conflict resolution system, according to an example embodiment.

### DETAILED DESCRIPTION

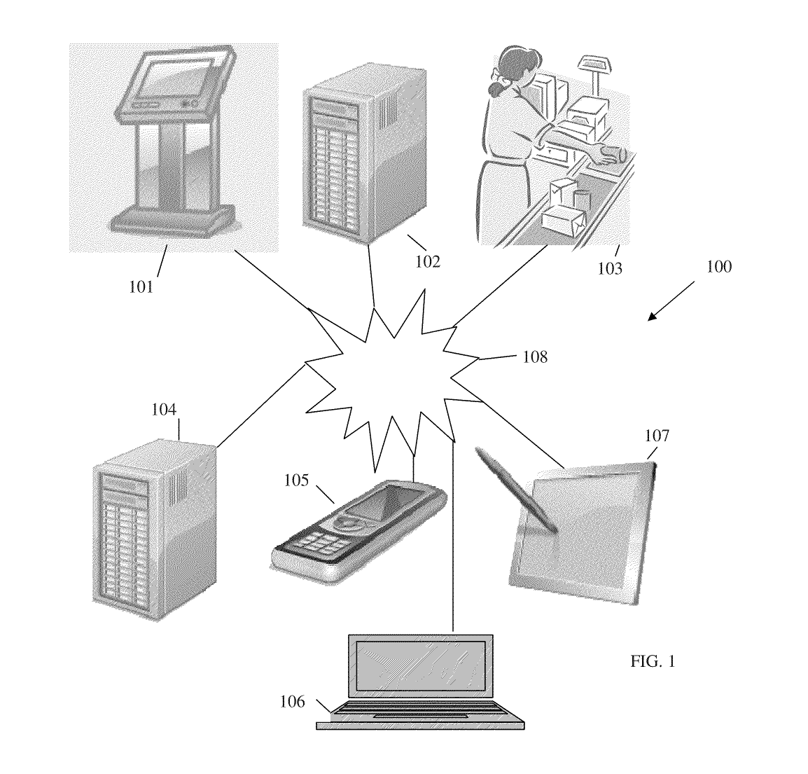

FIG. 1 is a diagram of an example architecture 100 for practicing promotion conflict resolution, according to an example embodiment. The various components are illustrated and the arrangement of the components is presented for purposes of illustration only. It is to be noted that other arrangements with more or less components are possible without departing from the promotion conflict resolution teachings presented herein and below.

The techniques and methods presented herein and below for promotion conflict resolution can be implemented in whole or in part in one, all, or some combination of the components shown with the architecture 100. The techniques and methods are programmed as executable instructions in memory and/or non-transitory computer-readable storage media and processed on one or more processors associated with the components.

Moreover, in an embodiment, the techniques or methods are implemented as part of a retail promotion engine that is responsible for executing promotion campaigns by rewarding the customer whose order meets defined promotion criteria. When a product or service is being promoted by multiple promotions, the promotion engine efficiently finds and executes the set of optimal promotions for all the conflicting promotions of the transaction (presumably this also yields an optimal reward for the transaction (each set of promotions applied to a transaction has its own reward value)). Two promotions are deemed to be conflicting when they both cannot reward the customer for the customer's transaction. So, in this way, conflicting promotions cannot be used by the customer in a given transaction. Resolving conflicting transactions is a non trivial task. For example, consider that N products in a transaction are conflicting with one another over K available promotions for that transaction. So, there are K^{N} total allocation options. It is apparent, that as the size of the products/services grow in a transaction along with available promotions that conflict, the problem associated with resolve a set of optimal promotions grows exponentially. Moreover, each selection of non-conflicting promotions for the products of the transaction yields its own reward value (discount of the price, credited reward loyalty points, and the like).

Again it is to be noted that the problem of selecting an optimal set of promotions for any given transaction grows exponentially in complexity with the number of products and available promotions for that transaction.

As will be demonstrated herein, the techniques for promotion conflict resolution search subsets of promotions for transaction with dynamic pruning of the search space (available promotions). Providing more efficiency in resolving a set of optimal promotions from a plurality of available promotions, some of which conflict with one another.

It is noted that “a set of optimal promotions” can include just one promotion. Essentially, a set of one. Therefore, as used herein “the set of optimal promotions” refers to one or more promotions.

Available promotions may include one or more promotions that conflict with one another. This does not have to mean that any two conflicting promotions are associated with a same product or service of the transaction, just that the two promotions in a given transactional situation cannot be used together for whatever reason. Moreover, a promotion can be: associated with a transaction as a whole, associated with a consumer of the transaction, associated with some loyalty attribute (loyalty level, reward points, etc.) of the consumer, associated with a product or service involved in the transaction, associated with a product or service not associated with any good/service in the transaction, associated with a specific date and/or time, or various combinations or all of these things.

As used here, the term “product,” “service,” and “good” may be used interchangeably to refer to something being purchased by a consumer from an enterprise. Moreover, the term “promotion” may be used interchangeably with the term “offer” to refer to something that provides a benefit to a consumer in some manner during a transaction. For example, the benefit may be increased reward points for the consumer, a free good with purchase of other goods, a discount on a good, and the like. Finally, the term “consumer” may be used interchangeably with the terms “customer” and “user” and these terms refer to an entity that is engaged in a transaction with an enterprise for which multiple available promotions exists (some of which conflict with others) and for which the techniques presented herein provide an efficient resolution for promotion conflict resolution.

An “optimal promotion” is a promotion that when compared to multiple other conflicting promotions/offers in view of transaction details (discussed below) is deemed to produce an “optimal” reward value for a customer in a given transaction. So, “optimal promotion” means a promotion providing a best reward for the customer of the transaction. The term “optimal” is based on predefined rules, such as: based on rules noted at the customer's direction (customer-defined rules) when conflicting promotional situations exists; based on currency discount value or price; based on reward credits; based on date/time; and others. In essence, an evaluation of available promotions (with some conflicting promotion) to a transaction (involving a specific customer, specifics goods/services, and/or enterprise performing the transaction) having transaction details is evaluated to select a set of optimal promotions based on defined rules, algorithms, and/or user direction. The definition of optimal is dynamically evaluated based on predefined rules and settings either associated with: the consumer, the enterprise, the good, or all or some combination of these things. It should also be noted that for any given evaluation of what is an optimal set of promotions for a given transaction (having conflicting promotions), the rules that define how to select what is optimal may be driven by the evaluation of the available promotions that exists for that transaction based on the transaction attributes.

It is within this context that the architecture 100 of the FIG. 1 is now discussed.

The architecture 100 can include: a kiosk 101, a server, 102, a self-service or cashier-assisted checkout device 103 (Point-Of-Sale (POS) 103 device), a loyalty/reward system server 104, a mobile phone 105, a computer/laptop 106, a tablet 107, and/or any other wearable device having processor capabilities (not shown in the FIG. 1). The components interact with one another over a network 108.

The network 108 can be peer-to-peer (P2P) via Bluetooth (including Low Energy Bluetooth), Near Field Communication (NFC), Radio Frequency (RF), dedicated lines, Internet-based P2P, and the like. The network 108 can also include wired and/or wireless communication associated with a Wide-Area Network (WAN) and/or a Local-Area Network (LAN). The network 108 can also include cellular, a virtual private network (VPN), WiFi, Internet Service Provider (ISP) WAN Internet Access, and the like. The point is that the network 108 can be achieved via a variety of approaches to interface the various components with one another to achieve the teachings presented herein and below.

A consumer decides to checkout or to complete a transaction with some enterprise. The transaction includes the purchase or potential purchase of one or more goods (products or services). This transaction can be identified or detected from a variety of user devices; some of these devices include a kiosk 101, a self-service or cashier-assisted checkout device 103, a consumer phone 105, a consumer computer or laptop 106, a tablet 107, and/or a wearable processing device (not shown in the FIG. 1).

It is to be noted that a transaction can include a consumer generated checkout at an enterprise (either online or physically at the site of the enterprise) or can include an enterprise generated marketing campaign that targets the consumer (the consumer qualifies as one candidate under the marketing campaign). That is, the transaction can be an enterprise initiated marketing campaign directed to targeted customers.

The transaction identifies a plurality of goods (products or services. The transaction may also identify a customer to which it is associated (but does not have to be the case). This can be done in a variety of manners, such as via entry of a phone number, swipe or entry of a loyalty card, use of a specific credit card, and the like. It is to be noted that the transaction may also identify a generic customer, such that the identity of the customer is unknown (that is, some customer exists for the transaction but the identity is anonymous). In the case, where the transaction is a marketing campaign, it can include a customer number that uniquely identifies the customer of class of customers generically (customer segment).

Once there is a transaction (originating from a customer or from an analyst initiating a marketing campaign), a dynamic attribute list can be assembled for that transaction (“transaction attributes”). The transaction attributes can be associated with just the transaction and be unrelated to any specific good/service associated with the transaction or any specific customer associated with the transaction. However, it is to be noted that, in some instances, the transaction attributes can also be associated with or even exclusively associated to identifiers for the goods/services and/or an identity for the customer. In some cases, a specific date or time can also generate transaction attributes for the transaction (for example, Valentine's Day all transactions are 10% off (promotion identified as a transaction attribute for a specific transaction)). The transaction attributes include attributes that are: credits, loyalty rewards, preferences (customer profile(s)), promotions, rules for identifying a set of optimal promotions from the promotions, rules for expanding the transaction attributes based on transaction details, and the like. The transaction details can include a variety of information, such as but not limited to: transaction identifier, date and time, enterprise of transaction, customer identity, identifiers for goods/services, prices and quantities associated with the goods/services of the transaction, and the like.

According to an embodiment, a mechanism to acquire some transaction attributes for a known customer accesses a loyalty/reward system 104; this provides customer preferences (profiles), loyalty level (gold, diamond, etc.), and other rules for expanding the transaction attributes (such as based on loyalty level offer increased loyalty reward points for transactions). It may also be that the loyalty/reward system 104 includes an enterprise marketing system 104 that provides promotions for goods/services of the transaction (of any transaction attribute for a given transaction); so, each promotion available for the transaction may be considered a transaction attribute for that transaction (as stated above).

The transaction attributes are then evaluated to acquire any customer-defined/provided transaction attributes that can alter the transaction, such as loyalty reward credits, customer-specific coupons, and the like. The transaction attributes are also evaluated for any good/service-specific promotions (types of transaction attributes). Still further, the transaction attributes are evaluated to acquire any date specific, enterprise specific, location specific, time specific, transaction specific, and/or store specific (promotions) that may or may not be related to the goods/services of the transaction and/or the customer. Each of these transaction attributes can have its own rules that determine when and how such transaction attributes can be redeemed or used. The rules are used with the transaction attributes to search and prune from available promotions (and combinations of available promotions) in view of conflicting promotions to produce a set of optimal promotions. The set of optimal promotions is then sent to an enterprise asset (kiosk 101, self-service or cashier-assisted checkout device 103, and/or server 102) and/or sent to a customer asset (phone 105, computer/laptop 106, tablet 107, and/or wearable processing device (not shown in the FIG. 1)). It may also be that the set of optimal promotions is emailed to an email account of the customer.

In some embodiments, the set of optimal promotions can also be included in an ordered list of sets of promotions (with the set of optimal promotions being the first set in the list). The ordered list is ordered based on decreasing reward value that the customer would achieve if he/she selected a particular set for use in the transaction. So, again, the set of promotions offering the best or “optimal” (can be user defined or can be based on a predefined rule, such as cost, or other rules) is the set of optimal promotions, the second set in the list is the next set having the next best reward value for the customer in the transaction, and so on. A predefined number of sets in the ordered set can be dynamically supplied to the customer for the customer to make a selection before applying to a transaction. This gives control to the customer. Moreover, the predefined number of sets from the ordered set (beginning with the set of optimal promotions) can be customer defined (such as via the customer profile).

The set of optimal promotions may then be redeemed or applied to the transaction to complete the transaction; this can be done automatically on behalf of the customer for the transaction or, the customer provided the set of optimal promotions and a predefined number of other sets of promotions from an ordered list of promotion sets for the customer to review and/or select from predefined number of sets of promotions.

It is also to be noted that just as it is very difficult for a customer to select a set of optimal promotion for even a small transaction (in some cases the customer may not even be aware of what promotions exist for the transaction as well), it is also equally as difficult for any cashier checking a customer out for a transaction to resolve a set of optimal promotions for the transaction (the cashier may even be unaware of some available promotions to which the customer may have access to and has little available time to manually computer all the possible permutations from the available promotions).

Consider some of the following scenarios. There a three bottles of wine A, B, and C. A costs $10; B costs $9; and C costs $7.50. Moreover, there are 4 promotions. Promotion 1 states that if a customer buys all three wines (A, B, and C), then the most expensive wine (A) is 50% off (so $5). Promotion 2 is 10% off A; promotion 2 is 20% off B; and promotion 4 is 30% of C. Suppose that a product can be rewarded by just one promotion (according to existing rules for the product(s) and/or the promotion). So, promotion 1 conflicts with promotions 2-4; but promotions 2-4 can be used together since each is applicable to a specific one of the wines (A, B, and C). Intuition might indicate to the customer that he/she wants the most expensive wine (A) for 50% off but to redeem the applicable first promotion the customer has to buy all three wines (A, B, and C) for a total price of $21.50 ($5 ($10 (A at a 50% discount) plus $9 (B) plus $7.50 (C)). However, the reality is that using promotions 2-4 is actually better for the customer because the total price is $21.45 (A-$9 ($10 discounted by 10%) plus $7.20 (B-$9 discounted by 20%) plus $5.25 (C-$7.50 discounted by 30%)). (Again, as used herein “an optimal set of promotions” refers to an “optional reward” for the customer in the transaction.) It is unlikely that the customer would take the time and effort to figure out that the best promotion is to use promotions 2-4 and yet with the techniques presented herein the customer does not have to expend any energy to figure this out, since the set of optimal promotions is automatically and seamlessly done for the customer.

The least expensive transaction (acquired by applying promotions to arrive at a maximum reduced price for the transaction) may not always be what the customer considers to be optimal. This is so because some promotions may give free other unrelated goods/services or may provide more loyalty reward credits. In other words, the comparison for what is optimal may not be a direct apples-to-apples comparison; rather, some subjective value assessment may need to be made by the customer. This can be achieved in a number of ways. For instance, the customer may have predefined preferences that provide an automatic indication as to what is to be considered optimal to the consumer in these situations. In another case, the customer may be automatically queried to provide a selection that the customer considers to be optimal in any given situation. Either of these scenarios may be used with the teachings presented herein. The customer can predefine, via preferences or profile, a selection when a situation is presented (for example, 50% off or an extra 1000 reward credits or points for a loyalty account). (This later situation was discussed above)

It is also noted that the search space for any given transaction can be enormous. For example consider that 9 products (goods) in a given transaction have over 5 promotions each, the complexity of scenarios can be in enormous (5⁹). As noted before, there may be promotions available for the transaction or customer that are also not associated with any specific product in the transaction. These promotions are also searched and are included as part of the search space (available promotions) for the given transaction.

The techniques presented herein, according to an embodiment map the available promotions search space for goods/services in a transaction and/or other transaction attributed (discussed above). Then, the search space is repeatedly searched and pruned applying mathematical marketing and decision theory practices and principals. This approach permits a set of optimal promotions to be resolved in fractions of a second.

For example, consider a real business scenario having 15 products with 13 promotions and a complexity of 10⁹: a typical approach would take nearly 3.5 days to resolve whereas the approach used herein can be achieved in roughly 200 milliseconds via the search space pruning technique.

Pseudo code for implementing one embodiment of the invention is attached as an Appendix.

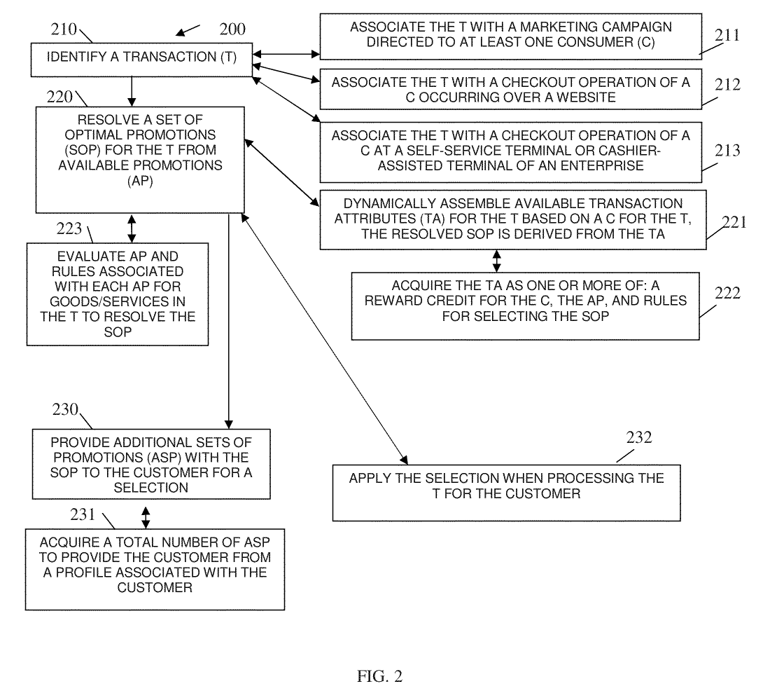

The above-discussed embodiments and other embodiments are now discussed with reference to the FIGS. 2-4.

FIG. 2 is a diagram of a method 200 for promotion conflict resolution, according to an example embodiment. The software module(s) that implement the method 200 is referred to as a “promotion resolver.” Moreover, the executable instructions for the promotion resolver are programmed and residing within memory and/or a non-transitory computer-readable (processor-readable) storage medium and executed by one or more processors of a device. The processors are specifically configured and programmed to process the promotion resolver. The promotion resolver has access to one or more networks. The networks are wired, wireless, or a combination of wired and wireless.

In an embodiment, the device that executes the promotion resolver is a self-service checkout device, a cashier-assisted checkout device, a server, a web portal device, a cloud environment having multiple devices, and/or a mobile device such as: a smart phone, a tablet, a laptop, or a wearable processing device (glasses, watch, etc.). In fact, the device can be multiple devices that act logically as one device.

At 210, the promotion resolver identifies a transaction. The identification of the transaction can occur in a variety of manners. Moreover, the promotion resolver can be executed in whole or in part in a variety of devices, such as the devices listed in the FIG. 1 and others (such as wearable processing devices).

According to an embodiment, at 211, the promotion resolver associates the transaction with a marketing campaign directed to at least one consumer. In other words, consider an enterprise analyst (user) that defines a marketing campaign for a customer segment for which the consumer qualifies based on conditions defined in the marketing campaign. The marketing campaign generates a transaction request that is identified by the promotion resolver. This can be a transaction to simulate the behavior of a customer during a given transaction as well.

In another case, at 212, the promotion resolver associates the transaction with a checkout operation of a consumer occurring over a website. That is, a consumer is purchasing one or more good/services over the internet using a web portal service and adds goods/services to a shopping cart when the consumer attempts to check out the transaction is identified.

In still another situation, at 213, the promotion resolver associates the transaction with a checkout operation of a consumer at a self-service terminal or a cashier-assisted terminal of an enterprise. So, the consumer can be checking himself/herself out or can be using a cashier to checkout when the transaction is identified by the promotion resolver.

At 220, the promotion resolver resolves a set of optimal promotions for the transaction from available promotions. Some of these available promotions (or sets of the available promotions) conflict with one another. Again, what is considered to be optimal can be consumer-defined or can be based on predefined configuration settings (identified as rules having conditions) and an “optimal promotion” is one in a given transaction based on the given transaction details yields what is considered to be an “optimal reward” for the customer of the transaction.

In an embodiment at 221, the promotion resolver dynamically assembles the available transaction attributes (defined above with the discussion of the FIG. 1) for the transaction based on a consumer for the transaction, wherein the set of optimal promotions is derived from the transaction attributes. This scenario was discussed above with reference to the FIG. 1. The consumer is also capable of being associated with a variety of transaction attributes, such as reward credits, coupons or discounts associated with the consumer based on reward level, promotions targeted to the consumer, and the like (again, transaction attributes). The goods/services in the transaction are also included transaction attributes as are promotions associated with each of the goods/services or associated with selective groupings of the goods/services. Transaction attributes can also be promotions not in any way associated with the goods/services of the transaction and/or the consumer (also discussed at length above). These transaction attributes are evaluated to resolve the set of optimal promotions (based on predefined standards included in rules having configured conditions defining what is to be considered “optimal” and optimal based on the customer reward applied to the transaction).

Continuing with the embodiment of 221 and at 222, the promotion resolver acquires the available transaction attributes as one or more of: a loyalty reward credit for the consumer, available promotions, and rules for selecting the set of optimal promotions.

In still another case, at 223, the promotion resolver evaluates available promotions and rules associated with each available promotion for goods/services in the transaction to resolve the set of optimal promotions. Each promotion or set of promotions may have its own promotion redemption rules; these are acquired and evaluated when resolving the set of optimal promotions.

In an embodiment, the promotion resolver applies Meta rules to resolve conflicts between multiple promotions (or combinations of the promotions) that span multiple goods/services for the transaction. In other words, there may be two available scenarios to select for the set of optimal promotions that cannot be directly compared with one another, such as a price versus reward points, loyalty reward points versus a free unrelated good, and the like, in these situations the Meta rules provide resolution to select the set of optimal promotions.

According to an embodiment, the promotion resolver repeatedly searches the available promotions for transaction attributes (discussed above) associated with the transaction and prunes a search space (available promotions) to resolve the set of optimal promotions.

In an embodiment, the promotion resolver prunes by applying marketing rules and decision theory rules.

According to an embodiment, at 230, the promotion resolver provides additional sets of promotions with the set of optimal promotions to the customer for a customer selection. Here, the customer may desire to see the top few sets of promotions to select what the customer wants to be considered optimal to produce an optimal (determined in real time or near real time) reward for the transaction in the subjective view of the customer.

In an embodiment of 230 at 232, the promotion resolver acquires a total number of additional sets of promotions to provide the customer from a profile associated with the customer. So, the customer can define how many sets of promotions (the first set being the set of optimal promotions) to be provided in 230.

In an embodiment of 232 and at 233, the promotion resolver applies a selected set based on the selection of the customer when processing the transaction for the customer. It is noted, the customer may independent apply the selected set manually in some embodiments as well.

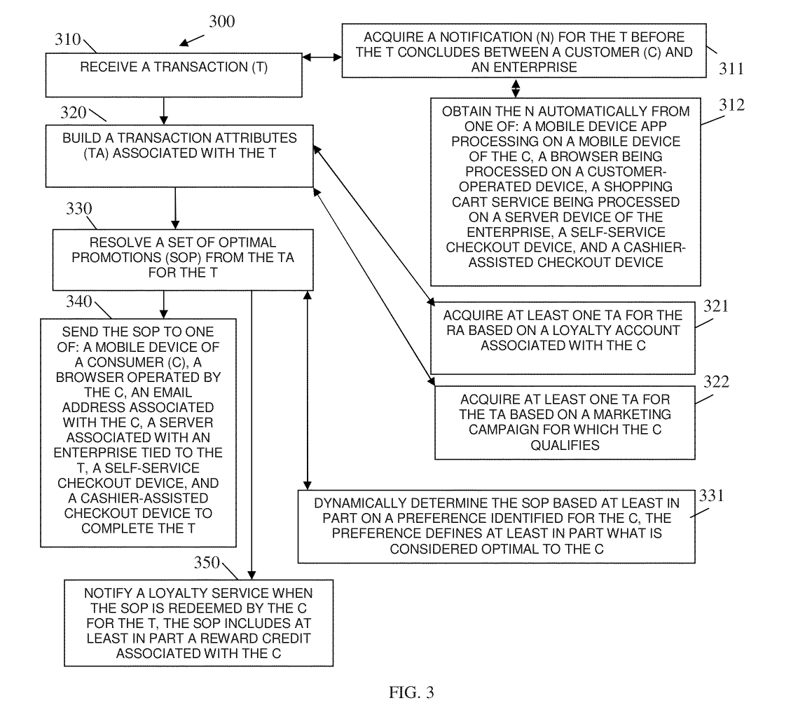

FIG. 3 is a diagram of another method 300 for promotion conflict resolution, according to an example embodiment. The software module(s) that implement the method 300 is referred to as a “promotion optimizer.” The executable instructions of the promotion optimizer are implemented as instruction and programmed within memory and/or a non-transitory computer-readable (processor-readable) storage medium that executes on one or more processors of a device; the processors of the device are specifically configured to execute the promotion optimizer. The promotion optimizer has access to one or more networks; the networks are wired, wireless, or a combination of wired and wireless.

In an embodiment, the device that processes the promotion optimizer is a remote server that interacts with a Point-Of-Sale (POS) terminal, such as a self-service checkout device and/or a cashier-assisted checkout device. In other cases, the device is integrated into the POS terminal.

The promotion optimizer is presented as another and in some ways enhanced perspective of the promotion resolver, which was presented above in detail with reference to the method 200 of the FIG. 2.

At 310, the promotion optimizer receives a transaction. This can be an indication of a transaction occurring with a customer (consumer or user).

In an embodiment, at 311, the promotion optimizer acquires a notification for the transaction before the transaction concludes between a customer and an enterprise. In other words, the promotion optimizer processes dynamically and during a transaction of a customer.

Continuing with the embodiment of 311 and at 312, the promotion optimizer obtains the notification automatically and without any manual intervention. The notification acquired from one of: a mobile device application (app) processing on a mobile device of the customer, a browser being processed on a customer-operated device, a shopping cart service being processed on a server device of the enterprise, a self-service checkout device, and a cashier-assisted checkout device.

At 320, the promotion optimizer builds transaction attributes associated with a transaction. Some example aspects of the transaction attributes were presented above with reference to the FIGS. 1 and 2.

In an embodiment, at 321, the promotion optimizer acquires at least one transaction attribute for the transaction attributes based on a loyalty account associated with the customer.

In another case, at 322, the promotion optimizer acquires at least one transaction attribute for the transaction attributes based on a marketing campaign for which the customer qualifies.

At 330, the promotion optimizer resolves a set of optimal promotions from the transaction attributes associated with the transaction.

According to an embodiment, at 331, the promotion optimizer dynamically determines the set of optimal promotions based at least in part on a preference identified for the customer. The preference defines at least in part what is considered to be optimal to the customer.

In an embodiment, at 340, the promotion optimizer sends the set of optimal promotions to one of: a mobile device of a customer, a browser operated by the customer, an email address associated with the customer, a server associated with an enterprise associated with the transaction, a self-service checkout device, and a cashier-assisted checkout device to complete the transaction.

In another situation, at 350, the promotion optimizer notifies a loyalty service when the set of optimal promotions is redeemed by a customer for the transaction. The set of optimal promotions includes at least in part a reward credit associated with the customer. This permits integration with a loyalty/reward system, such as what was explained in the FIG. 1 above.

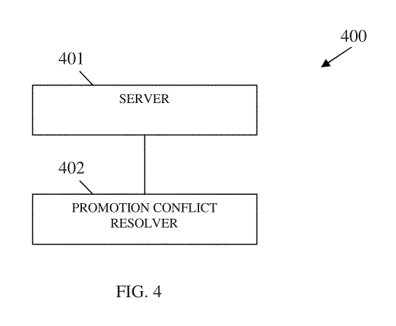

FIG. 4 is a diagram of a promotion conflict resolution system 400, according to an example embodiment. The components of the promotion conflict resolution system 400 are programmed and reside within memory and/or a non-transitory computer-readable medium and execute on one or more processors of one or more devices. The promotion conflict resolution system 400 is operational over a network and the network can be wired, wireless, or a combination of wired and wireless.

The promotion conflict resolution system 400 includes a server 401 having a promotion conflict resolver module 402.

The promotion conflict resolution system 400 includes a server 401 or cloud processing environment 401 having the promotion conflict resolver module 402 programmed within memory and/or a non- transitory computer-readable storage media as executable instructions. The server 401 or cloud processing environment 402 executes the promotion conflict resolver module 402. Example aspects associated with the promotion conflict resolver module 402 were presented above with reference to the FIGS. 2 and 3 (discussed as the promotion resolver and the promotion optimizer).

The promotion conflict resolver module 402 is operable or configured to dynamically resolve a set of optimal promotions for a transaction of a consumer from available promotions some of which may or may not conflict with one another.

According to an embodiment, the transaction is associated with one of: a marketing campaign that includes the consumer and a purchase by the consumer of a good or service associated with an enterprise.

According to an embodiment, the promotion conflict resolver is further operable to present additional sets of promotions with the set of optimal promotions to the customer for a selection during the processing of the transaction. So, sets of promotions that can be applied to the transaction without conflict are ordered, the top or first set in that ordered list is the set of optimal promotions (providing what is considered to be an optimal reward to the customer for the transaction), the remaining ordered sets are ordered based on reward value to the customer, the best reward value being the second set in the ordered list. The customer (via a profile) can define how many of the additional sets to be presented with the set of optimal promotions to make a customer selection, which can be applied to the transaction.

In an implementation of one embodiment for resolving a set of optimal promotions is attached in an Appendix.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

### APPENDIX A

| Symbol | Explanation |
|---|---|
| [ ] | Empty array |
| [a₁, . . . , aₙ] | Non-empty array |
| A[n] | Nth element of array A |
| { } | Empty set |
| {a₁, . . . , aₙ} | Non-empty set |
| ← | Assignment |
| [symbol] | Implies |
| = | Definition |
| \ | Set difference |
| ⊂ | Subset |
| ⊂ | Proper subset |
| _{P}{exp₁ Binary Operator exp₂} | A Predicate |

Algorithm 1: RESOLVEPROMOTIONCONFLICT(P,R,s_{feas})
Finds an optimal resource allocation plan

Input: An array P = [p₁,...,pₙ] of promotions, a set

R = {r₁,r₂,...,rₘ} of resources, a feasible solution s_{feas}

| | Output: An optimal solution sₘₐₓ | |
|---|---|---|
| 1 | P ← SORTBYMAXREWARD(P) | // sort descending |

| | | |
|---|---|---|
| 2 | S ← BUILDINITIALSOLUTIONS(R) | // initial solutions array |

| | | |
|---|---|---|
| 3 | lb ← reward(s_{feas}) | // a lower bound reward value |

| | | |
|---|---|---|
| 4 | potentialReward ← Σ₁ⁿ maxReward(pᵢ) | // total potential reward |

| 5 | for i ← 1 to n do | |
|---|---|---|
| | \| | // build all possible resource allocations for pᵢ |
| 6 | \| | Sₛₚₐₙ ← SPANPROMOTIONSOLUTIONS(S,pᵢ) |
| | \| | // update the potential remaining reward and prune |
| 7 | \| | potentialReward ← potentialReward − maxReward(pᵢ) |
| 8 | \|_{—} | S ← PRUNE(Sₛₚₐₙ,potentialReward,lb) |

| 9 | S ← APPEND(S,s_{feas}) | // handle case of S = |
|---|---|---|
| | | [ ] |
| 10 | sₘₐₓ ← arg max_{s∈S} reward(s) | // find the best solution |

| | |
|---|---|
| 11 | return sₘₐₓ |

Algorithm 2: SORTBYMAXREWARD(P)
TODO

Input: An array P of promotions
Output: An array Pᵣₑₛᵤₗₜ of promotions
Abstract: Returns an array Pᵣₑₛᵤₗₜ = [p₁,...,pₙ] of promotions such

that:

| | | |
|---|---|---|
| 1 | ∀i < j ₚ{maxReward(pᵢ) ≧ maxReward(pⱼ)} | // sort descending |

| | | |
|---|---|---|
| 2 | Pᵣₑₛᵤₗₜ is a permutation of P | // one-to-one correspondence |

Algorithm 3: BUILDINITIALSOLUTIONS(R)
Builds an initial solutions array

Input: A set R = {r₁,...,rₙ} of resources
Output: An array Sᵣₑₛᵤₗₜ = [sᵢₙᵢₜ] of solutions that contains sᵢₙᵢₜ, a

solution where all resources are unallocated

| | | |
|---|---|---|
| 1 | allocations(sᵢₙᵢₜ) ← [ ] | // no allocations |

| | | |
|---|---|---|
| 2 | reward(sᵢₙᵢₜ) ← 0 | // no reward |

| | |
|---|---|
| 3 | freeResources(sᵢₙᵢₜ) ← R // all resources are unallocated |
| 4 | Sᵣₑₛᵤₗₜ ← [sᵢₙᵢₜ] |
| 5 | return Sᵣₑₛᵤₗₜ |

Algorithm 4: PRUNE(S,potential,lb)
Prunes solutions

Input: An array of solutions S, a potential reward value potential, a

lower bound reward value lb

| | Output: An array of solutions S |
|---|---|
| 1 | Sₚₒₜₑₙₜᵢₐₗ ← PRUNEBYLOWERBOUND(S,potential,lb] |
| 2 | Sᵣₑₛᵤₗₜ ← PRUNEBYFREERESOURCES(Sₚₒₜₑₙₜᵢₐₗ) |
| 3 | return Sᵣₑₛᵤₗₜ |

Algorithm 5: SPANPROMOTIONSOLUTIONS(S,p)
Spans all valid solutions with a given promotion

| | Input: An array S of solutions, a promotion p | | |
|---|---|---|---|
| | Output: An array Sᵣₑₛᵤₗₜ of solutions | | |
| 1 | Sᵣₑₛᵤₗₜ ← [ ] | | |
| 2 | G ← GROUPBYFREERESOURCES(S) | | |
| 3 | foreach group in G do | | |
| 4 | \| | R_{group} ← freeResources(group) // the group free resources | |
| | \| | // get all valid allocations for R_{group} | |
| 5 | \| | A_{group} ← SPANRESOURCEALLOCATIONS(p, R_{group}) | |
| 6 | \| | S_{group} ← solutions(group) | // the group solutions |

| | \| | // append all allocations to all group solutions | | |
|---|---|---|---|---|
| 7 | \| | foreach s in S_{group} do | | |
| 8 | \| | \| | foreach a in A_{group} do | |
| 9 | \| | \| | \| | sₐ← APPENDALLOCATIONTOSOLUTION(s,a) |
| 10 | \|_{—} | \|_{—} | \|_{—} | Sᵣₑₛᵤₗₜ← APPEND(Sᵣₑₛᵤₗₜ,sₐ) |

| | |
|---|---|
| 11 | return Sᵣₑₛᵤₗₜ |

Algorithm 6: SPANRESOURCEALLOCATIONS(p,R)
Spans all valid resource allocations for promotion p,
including the allocation of no resources

Input: A promotion p , a set R = {r₁,...,rₘ} of resources
Output: An array A of allocations
Abstract: Returns an array of all allocations [A₁,...,Aₙ] where

Rᵢ ≐ usedResources(Aᵢ) such that ∀ᵢ ≠ j ∀R_{sub} ⊂Rᵢ

| | | |
|---|---|---|
| 1 | Rᵢ ⊂ R | // resources are subset of R |

| | |
|---|---|
| 2 | Rᵢ ≠ Rⱼ // resource allocation is unique |
| | // subset allocation results in smaller reward value |
| 3 | CALCREWARD(p,Rᵢ) > CALCREWARD(p,R_{sub}) |

Algorithm 7: CALCREWARD(p,R)
Calculates the reward value when associating
resources with a promotion

Input: A promotion p , a set R = {r₁,...,rₘ} of resources
Output: A numeric value v
Abstract: Returns a numeric value v that represents the benefit

rewarded when promotion p is exclusively associated with all
resources r ∈ R

Algorithm 8: APPENDALLOCATIONTOSOLUTION(s,a)
Appends allocation to an existing solution

| | Input: A solution s, an allocation a | |
|---|---|---|
| | Output: A solution s_{new} | |
| 1 | allocations(s_{new}) ← APPEND(allocations(s),a) | // commit a |

| | | |
|---|---|---|
| 2 | reward(s_{new}) ← reward(s) + reward(a) | // aggregate a's reward |

| | |
|---|---|
| | // used allocation resources can not be rewarded again |
| 3 | freeResources(s_{new}) ← freeResources(s) \ usedResources(a) |
| 4 | return s_{new} |

Algorithm 9: PRUNEBYLOWERBOUND(S,potential,lowerBound)
Prunes solutions which are incapable of crossing the lower bound

Input: An array S of solutions, remaining potential reward value

potential, lower bound value lowerBound

| | Output: An array Sᵣₑₛᵤₗₜ of solutions | | |
|---|---|---|---|
| 1 | Sᵣₑₛᵤₗₜ ← [ ] | | |
| 2 | foreach s in S do | | |
| | \| | // retain solutions that potentially cross the lower bound | |
| 3 | \| | if reward(s) + potential > lower Bound then | |
| 4 | \|_{—} | \|_{—} | Sᵣₑₛᵤₗₜ ← APPEND(Sᵣₑₛᵤₗₜ,s) |

| | |
|---|---|
| 5 | return Sᵣₑₛᵤₗₜ |

Algorithm 10: PRUNEBYFREERESOURCES(S)
Retains the highest reward solution in solution
groups of identical free resources

| | Input: An array S of solutions | | |
|---|---|---|---|
| | Output: An array Sᵣₑₛᵤₗₜ of solutions | | |
| 1 | Sᵣₑₛᵤₗₜ ← [ ] | | |
| 2 | G ← GROUPBYFREERESOURCES(S) | | |
| 3 | foreach group in G do | | |
| 4 | \| | S_{group} ← solutions(group) | // the group solutions |

| | | |
|---|---|---|
| | \| | // retain only one solution from every group |
| 5 | \| | sₘₐₓ ← arg max_{s∈S}_{_{group}} reward(s) |
| 6 | \|_{—} | Sᵣₑₛᵤₗₜ ← APPEND(Sᵣₑₛᵤₗₜ,sₘₐₓ) |

| | |
|---|---|
| 7 | return Sᵣₑₛᵤₗₜ |

Algorithm 11: APPEND(A,a*)
Append an element to an array

| | Input: An array A = [a₁,...,aₙ], an element a* |
|---|---|
| | Output: An array Aᵣₑₛᵤₗₜ |
| 1 | Aᵣₑₛᵤₗₜ ← [a₁,...,aₙ,a*] |
| 2 | return Aᵣₑₛᵤₗₜ |

Algorithm 12: GROUPBYFREERESOURCES(S)
Groups solutions by free resources attribute

| | Input: An array S of solutions |
|---|---|
| | Output: An array G of groups of solutions |
| | Abstract: Returns an array G of groups of solutions such that: |
| 1 | ∀s ∈ S ∃g ∈ G ₚ{s ∈ g [symbol] freeResources(s) = freeResources(g)} |
| 2 | ∀g₁, g₂ ∈ G ₚ{freeResources(g₁) ≠ freeResources(g₂)} |

1. A method, comprising:
identifying, via a device, a transaction; and
resolving, via the device, a set of optimal promotions for the transaction from available promotions.

2. The method of claim 1, wherein identifying further includes associating the transaction with a marketing campaign directed to at least one consumer.

3. The method of claim 1, wherein identifying further includes associating the transaction with a checkout operation of a consumer occurring over a website.

4. The method of claim 1, wherein identifying further includes associating the transaction with a checkout operation of a consumer at one of: a self-service terminal and a cashier-assisted terminal of an enterprise.

5. The method of claim 1, wherein resolving further includes dynamically assembling available transaction attributes for the transaction based on a consumer for the transaction, the set of optimal promotions derived from the available transaction attributes.

6. The method of claim 5, wherein dynamically assembling further includes acquiring the available transaction attributes as one or more of: a loyalty reward credit for the consumer, the available promotions, and rules for selecting the set of optimal promotions.

7. The method of claim 1, wherein resolving further includes evaluating the available promotions and rules associated with each available promotion for goods/services in the transaction to resolve the set of optimal promotions.

8. The method of claim 1 further comprising, providing one or more additional sets of promotions with the set of optimal promotions to a customer for a selection.

9. The method of claim 8, wherein providing further includes acquiring a total number of the one or more additions sets of promotions to provide the customer from a profile associated with the customer.

10. The method of claim 8 further comprising, applying a selection when processing the transaction for the customer.

11. A method, comprising:
receiving, by a device, a transaction;
building, by the device, transaction attributes associated with a transaction; and
resolving, by the device, a set of optimal promotions from the transaction attributes.

12. The method of claim 11 further comprising, sending by the device, the set of optimal promotions to one of: a mobile device of a customer, a browser operated by the customer, an email address associated with the customer, a server associated with an enterprise associated with to the transaction, a self-service checkout device, and a cashier-assisted checkout device to complete the transaction.

13. The method of claim 11 further comprising, notifying, by the device, a loyalty service when the optimal promotion is redeemed by a customer for the transaction, the optimal promotion includes at least in part a loyalty reward credit associated with the customer.

14. The method of claim 11, wherein receiving further includes acquiring a notification for the transaction before the transaction concludes between a customer and an enterprise.

15. The method of claim 14, wherein acquiring further includes obtaining the notification automatically from one of: a mobile device application processing on a mobile device of the customer, a browser being processed on a customer-operated device, a shopping cart service being processed on a server device of the enterprise, a self-service checkout device, and a cashier-assisted checkout device.

16. The method of claim 11, wherein building further includes acquiring at least one transaction attribute for the transaction attributes based on a loyalty account associated with a customer.

17. The method of claim 11, wherein building further includes acquiring at least transaction attribute for the transaction attributes based on a marketing campaign for which at least one customer qualifies.

18. The method of claim 11, wherein resolving further includes dynamically determining the set of optimal promotions based at least in part on a preference identified for a customer, the preference defines at least in part what is considered optimal to the customer.

19. A system, comprising:
a server having a promotion conflict resolver module that executes on one or more processors of the server; and
the promotion conflict resolver module operable to dynamically resolve a set of optimal promotions for a transaction from available promotions during processing of a transaction for a customer.

20. The system of claim 19, wherein the promotion conflict resolver is further operable to present additional sets of promotions with the set of optimal promotions to the customer for a selection during the processing of the transaction.
